(19) United States
(12) Patent Application Publication
(10) Pub. No.: US 2024/0406602 A1
(43) Pub. Date: Dec. 5, 2024

(54) IMAGING DEVICE AND ELECTRONIC APPARATUS

(71) Applicant: SONY SEMICONDUCTOR SOLUTIONS CORPORATION, KANAGAWA (JP)

(72) Inventors: DAIKI SAKUMA, KANAGAWA (JP); SHINICHIROU ETOU, KANAGAWA (JP)

(21) Appl. No.: 18/700,374

(22) PCT Filed: Sep. 6, 2022
(86) PCT No.: PCT/JP2022/033344

§ 371 Date: Apr. 11, 2024

(30) Foreign Application Priority Data
Oct. 20, 2021 (JP) 2021-171773

(51) Int. Cl. H04N 25/772; H04N 25/78

(52) U.S. Cl. CPC H04N 25/772; H04N 25/78

(57) ABSTRACT

[Object]

Provided is an imaging device that can improve a decrease in image quality caused by the offset of a successive approximation register analog-to-digital converter.

[Solving Means]

The imaging device of the present disclosure includes a pixel, and a successive approximation register analog-to-digital converter. The successive approximation register analog-to-digital converter includes a preamplifier, and a comparator. The preamplifier includes a first input transistor, a second input transistor, an auto-zero switch element configured to reset gate potentials of the first input transistor and the second input transistor before initial digital conversion processing, a cancel capacitor configured to charge a charge corresponding to an offset during resetting of the first input transistor and the second input transistor, a feedback capacitor configured to make, during comparison by the comparator, a gain of the preamplifier larger than the gain during the resetting, and a reset switch element configured to reset potentials of the pair of output terminals every time the comparison by the comparator is completed.

### TECHNICAL FIELD

The present disclosure relates to an imaging device and an electronic apparatus.

### BACKGROUND ART

In some imaging devices, a successive approximation resistor (SAR) analog-to-digital converter, for example, is mounted as an analog-to-digital converter configured to digitally convert the analog pixel signals output from pixels. The successive approximation register analog-to-digital converter includes a preamplifier configured to amplify the input voltage and a comparator configured to compare the voltage amplified by the preamplifier.

### CITATION LIST

### Patent Literature

### [PTL 1]

Japanese Patent Laid-open No. 2019-092143

### SUMMARY

### Technical Problem

In the successive approximation register analog-to-digital converter, the offsets of the preamplifier and comparator tend to increase depending on the temperature. As these offsets increase, vertical stripes may appear in the images, leading to a decrease in image quality in some cases.

Thus, the present disclosure provides an imaging device and an electronic apparatus that can improve a decrease in image quality caused by the offset of a successive approximation register analog-to-digital converter.

### Solution to Problem

An imaging device of the present disclosure includes a pixel configured to photoelectrically convert incident light, and a successive approximation register analog-to-digital converter configured to perform digital conversion processing a plurality of times on an analog signal generated on the basis of photoelectric conversion by the pixel. The successive approximation register analog-to-digital converter includes a preamplifier configured to amplify a voltage input to each of an inverting input terminal and a non-inverting input terminal, and a comparator configured to compare voltages input from respective ones of a pair of output terminals of the preamplifier to each other. The preamplifier includes a first input transistor having a gate connected to the inverting input terminal, a second input transistor having a gate connected to the non-inverting input terminal, an auto-zero switch element configured to reset gate potentials of the first input transistor and the second input transistor before initial digital conversion processing, a cancel capacitor configured to charge a charge corresponding to an offset during resetting of the first input transistor and the second input transistor, a feedback capacitor configured to make, during comparison by the comparator, a gain of the preamplifier larger than the gain during the resetting, and a reset switch element configured to reset potentials of the pair of output terminals every time the comparison by the comparator is completed.

The preamplifier may further include a first load transistor connected in series to the first input transistor, and a second load transistor connected in series to the second input transistor.

The auto-zero switch element may include a first auto-zero switch element and a second auto-zero switch element connected in series between the gate of the first input transistor and the gate of the second input transistor, a third auto-zero switch element provided between a gate and a drain of the first load transistor, and a fourth auto-zero switch element provided between a gate and a drain of the second load transistor.

The cancel capacitor may include a first cancel capacitor provided between the gate and a source of the first load transistor, and a second cancel capacitor provided between the gate and a source of the second load transistor.

The feedback capacitor may include a first feedback capacitor provided between the gate of the first load transistor and a drain of the second input transistor, and a second feedback capacitor provided between the gate of the second load transistor and a drain of the first input transistor.

The reset switch element may include a first reset switch element and a second reset switch element connected in series between the pair of output terminals.

The reset switch element may include a first reset switch element provided between one of the pair of output terminals and a power line, and a second reset switch element provided between another of the pair of output terminals and the power line.

The reset switch element may include a first reset switch element provided between one of the pair of output terminals and a ground line, and a second reset switch element provided between another of the pair of output terminals and the ground line.

A potential of a connection portion between the first reset switch element and the second reset switch element may be maintained at any potential between a power supply voltage and a ground potential.

The first input transistor and the second input transistor may be N-channel MOS transistors.

The first load transistor and the second load transistor may be P-channel MOS transistors.

The first input transistor and the second input transistor may be P-channel MOS transistors.

The first load transistor and the second load transistor may be N-channel MOS transistors.

The reset switch element may reset the potentials of the pair of output terminals in a time between an auto-zero period in which the auto-zero switch element resets the gate potentials of the first input transistor and the second input transistor, and an initial comparison period of the comparator.

The reset switch element may not reset the potentials of the pair of output terminals when the auto-zero switch element resets the gate potentials of the first input transistor and the second input transistor.

As soon as the comparison by the comparator is completed, the reset switch element may start to reset the potentials of the pair of output terminals.

An imaging device of the present disclosure is an electronic apparatus including an imaging device, the imaging device including a pixel configured to photoelectrically convert incident light, and a successive approximation register analog-to-digital converter configured to perform digital conversion processing a plurality of times on an analog signal generated on the basis of photoelectric conversion by the pixel, in which the successive approximation register analog-to-digital converter includes a preamplifier configured to amplify a voltage input to each of an inverting input terminal and a non-inverting input terminal, and a comparator configured to compare voltages input from respective ones of a pair of output terminals of the preamplifier to each other, and the preamplifier includes a first input transistor having a gate connected to the inverting input terminal, a second input transistor having a gate connected to the non-inverting input terminal, an auto-zero switch element configured to reset gate potentials of the first input transistor and the second input transistor before initial digital conversion processing, a cancel capacitor configured to charge a charge corresponding to an offset during resetting of the first input transistor and the second input transistor, a feedback capacitor configured to make, during comparison by the comparator, a gain of the preamplifier larger than the gain during the resetting, and a reset switch element configured to reset potentials of the pair of output terminals every time the comparison by the comparator is completed.

### BRIEF DESCRIPTION OF DRAWINGS

FIG. 1 is a block diagram depicting the schematic configuration of an imaging device according to a first embodiment.

FIG. 2 is a circuit diagram depicting an example of the configuration of a pixel.

FIG. 3 is a plan view schematically depicting an outline of a flat semiconductor chip structure of the imaging device.

FIG. 4 is an exploded perspective view schematically depicting the outline of the stacked chip structure of the imaging device.

FIG. 5 is a circuit diagram depicting the schematic configuration of a column signal processing system.

FIG. 6 is a diagram depicting the circuit configurations of a preamplifier and a comparator according to the first embodiment.

FIG. 7 is a timing chart depicting the operation of a successive approximation register analog-to-digital converter according to the first embodiment.

FIG. 8 is a diagram depicting the circuit configuration of a preamplifier according to a first modified example.

FIG. 9 is a diagram depicting the circuit configuration of a preamplifier according to a second modified example.

FIG. 10 is a diagram depicting the circuit configuration of a preamplifier according to a third modified example.

FIG. 11 is a diagram depicting the circuit configuration of a preamplifier according to a fourth modified example.

FIG. 12 is a timing chart depicting how the successive approximation register analog-to-digital converter operates according to a fifth modified example.

FIG. 13 is a block diagram depicting an example of the system configuration of an indirect TOF distance image sensor according to a second embodiment.

FIG. 14 is a circuit diagram depicting an example of the circuit configuration of a pixel according to the second embodiment.

FIG. 15 is a block diagram depicting a configuration example of an electronic apparatus according to a third embodiment.

FIG. 16 is a block diagram depicting an example of schematic configuration of a vehicle control system.

FIG. 17 is a diagram of assistance in explaining an example of installation positions of an outside-vehicle information detecting section and an imaging section.

### DESCRIPTION OF EMBODIMENTS

The basic configuration of an imaging device to which the technology according to the present disclosure is applied is described. Here, a description is given by taking, as the imaging device, an X-Y address CMOS (Complementary Metal Oxide Semiconductor) image sensor as an example. The CMOS image sensor is an image sensor manufactured by applying or partially using the CMOS process.

### First Embodiment

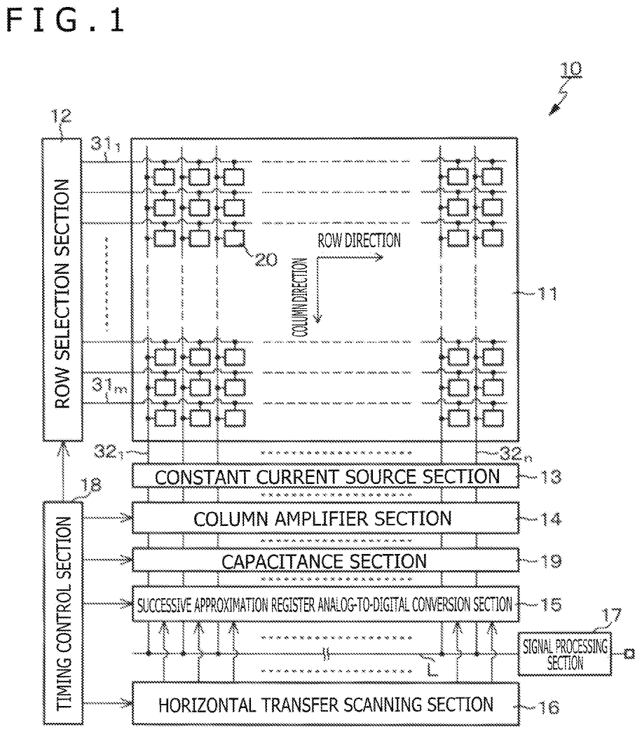

FIG. 1 is a block diagram depicting the schematic configuration of an imaging device according to a first embodiment. An imaging device 10 according to the present embodiment includes a pixel array section 11 and a peripheral circuit section around the pixel array section 11. The pixel array section 11 includes pixels (pixel circuits) 20, which includes photoelectric conversion elements, two-dimensionally arranged in row and column directions, that is, in a matrix. Here, the row direction refers to the array direction of the pixels 20 in a pixel row, and the column direction refers to the array direction of the pixels 20 in a pixel column. The pixels 20 perform photoelectric conversion to generate photo charges corresponding to the amount of received light and accumulate the photo charges.

The peripheral circuit section around the pixel array section 11 includes, for example, a row selection section 12, a constant current source section 13, a column amplifier section 14, an analog-to-digital conversion section 15, a horizontal transfer scanning section 16, a signal processing section 17, a timing control section 18, and a capacitance section 19.

In the pixel array section 11, pixel control lines 31 (31₁ to 31ₘ) are arranged in the row direction for the respective pixel rows in the matrix pixel array. Further, signal lines 32 (32₁ to 32ₙ) are arranged in the column direction for the respective pixel columns. The pixel control lines 31 transmit drive signals for driving during the reading of signals from the pixels 20. FIG. 1 depicts each pixel control line 31 as a single line, but each pixel control line 31 is not limited to a single line. One ends of the pixel control lines 31 are connected to the output ends corresponding to the respective rows of the row selection section 12.

The row selection section 12 includes a shift register, an address decoder, and the like, and controls the scanning of the pixel rows and the addresses of the pixel rows during the selection of each pixel 20 of the pixel array section 11. The row selection section 12, the specific configuration of which is not depicted, generally includes two scanning systems, namely, a read scanning system and a sweep scanning system.

To read pixel signals from the pixels 20, the read scanning system selectively scans the pixels 20 of the pixel array section 11 in units of row in sequence. The pixel signals read from the pixels 20 are analog signals. The sweep scanning system performs sweep scanning on the to-be-read row on which read scanning is to be performed by the read scanning system, prior to the read scanning by the time corresponding to the shutter speed.

This sweep scanning by the sweep scanning system sweeps out unnecessary charges from the photoelectric conversion elements of the pixels 20 in the to-be-read row, thereby resetting the photoelectric conversion elements. Then, with this sweeping (resetting) of unnecessary charges by the sweep scanning system, what is called the electronic shutter operation is performed. Here, the electronic shutter operation refers to the operation of discarding the photo charges in the photoelectric conversion elements and starting a new exposure (starting to accumulate photo charges).

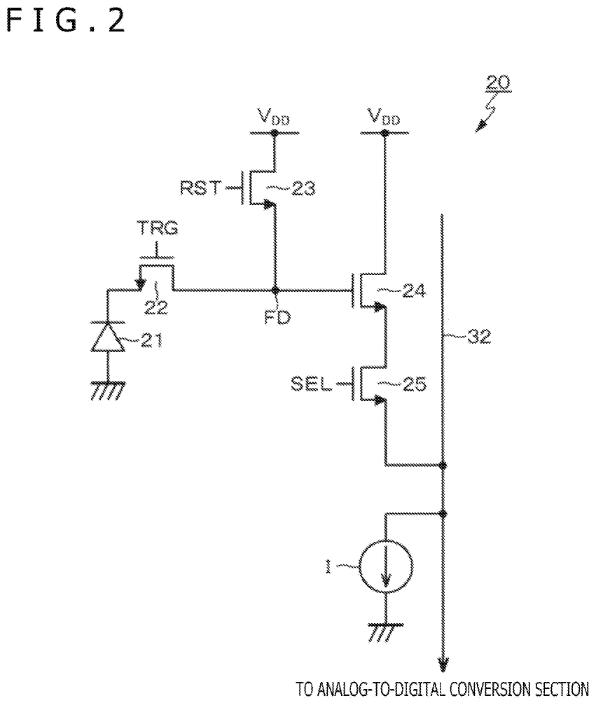

The constant current source section 13 includes a plurality of load current sources I (see FIG. 2), which includes MOS transistors, for example, connected to the respective signal lines 32₁ to 32ₙ for the respective pixel columns, and supplies a bias current to each pixel 20 in the pixel rows selectively scanned by the row selection section 12 through the respective signal lines 32₁ to 32ₙ.

The column amplifier section 14 includes a plurality of column amplifiers 140 (not depicted in FIG. 1) provided in correspondence with the respective signal lines 32₁ to 32ₙ for the respective pixel columns. The column amplifier section 14 performs processing that takes the difference between a signal component (what is called D phase) input from each pixel 20 of the pixel array section 11 through a corresponding one of the signal lines 32 and a reset component (what is called P phase) (CDS processing). The column amplifier section 14 outputs the difference as a pixel signal. The capacitance section 19 is provided in the latter stage of the column amplifier section 14.

The capacitance section 19 holds the pixel signals input from the column amplifier section 14 through sampling by switched capacitors, for example. The analog-to-digital conversion section 15 is provided in the latter stage of the capacitance section 19.

The analog-to-digital conversion section 15 includes a plurality of successive approximation register (SAR) analog-to-digital converters 150 (not depicted in FIG. 1) provided in correspondence with the pixel columns (for example, provided for the respective pixel columns) of the pixel array section 11. In the present embodiment, the successive approximation register analog-to-digital converters 150 convert the analog pixel signals input from the capacitance section 19 into digital pixel signals. A successive approximation register analog-to-digital converter alone is, in principle, more efficient than a single-slope analog-to-digital converter, which performs sweeping, since the successive approximation register analog-to-digital converter performs binary search. Further, CDS processing that has been performed by analog-to-digital conversion twice in related-art analog-to-digital converters is performed in the column amplifier section 14 of the analog circuit system, and hence the number of analog-to-digital conversions can be reduced by half. Moreover, the introduction of sampling by switched capacitors eliminates the need for a potential VSL of the signal lines to wait for analog-to-digital conversion, and sampling is thus always performed all at once without dependence on the potential VSL of the signal lines 32. The impact of interference caused by switching is therefore small.

The horizontal transfer scanning section 16 includes a shift register, an address decoder, and the like, and controls the scanning of the pixel columns and the addresses of the pixel columns during the reading of signals from each pixel 20 of the pixel array section 11. Under this control by the horizontal transfer scanning section 16, the pixel signals converted into digital signals by the analog-to-digital conversion section 15 are read to a horizontal transfer line L in units of pixel column.

The signal processing section 17 performs predetermined signal processing on the digital pixel signals supplied through the horizontal transfer line L to generate two-dimensional image data. For example, the signal processing section 17 performs digital signal processing such as correction of vertical line defects and point defects, parallel-to-serial conversion, compression, encoding, addition, averaging, and intermittent operations. The signal processing section 17 outputs the generated image data to a device in the latter stage as an output signal of the imaging device 10.

The timing control section 18 generates various timing signals, clock signals, control signals, and the like, and controls, on the basis of these generated signals, the driving of the row selection section 12, the constant current source section 13, the column amplifier section 14, the analog-to-digital conversion section 15, the horizontal transfer scanning section 16, the signal processing section 17, and the like.

FIG. 2 is a circuit diagram depicting an example of the configuration of the pixel 20. The pixel 20 includes a photoelectric conversion element 21, a transfer transistor 22, a reset transistor 23, an amplification transistor 24, and a selection transistor 25.

The transfer transistor 22, the reset transistor 23, the amplification transistor 24, and the selection transistor 25 include, for example, N-channel MOS field-effect transistors (FETs). However, the combination of the conductivity types of these four transistors is merely an example, and the present disclosure is not limited to this combination.

For each pixel 20 in the same pixel row, a corresponding one of the plurality of pixel control lines 31 described above is disposed as a common pixel control line. These pixel control lines 31 are connected to the output ends corresponding to the respective pixel rows of the row selection section 12 in units of pixel row. The row selection section 12 appropriately outputs a transfer signal TRG, a reset signal RST, and a selection signal SEL to the plurality of pixel control lines.

The photoelectric conversion element 21 includes a photodiode configured to photoelectrically convert incident light, for example. The anode of the photoelectric conversion element 21 is connected to a low potential-side power supply (for example, ground). The photoelectric conversion element 21 photoelectrically converts the received light into photo charges (here, photoelectrons) with the amount of charge corresponding to the amount of light and accumulates the photo charges. The cathode of the photoelectric conversion element 21 is electrically connected to the gate of the amplification transistor 24 via the transfer transistor 22. Here, the region in which the gate of the amplification transistor 24 is electrically connected is a floating diffusion (floating diffusion region/impurity diffusion region) FD. The floating diffusion FD is a charge-to-voltage conversion section for converting charges into voltage.

The gate of the transfer transistor 22 receives the transfer signal TRG, which is active at a high level (for example, V_{DD} level), from the row selection section 12. The transfer transistor 22 becomes conductive in response to the transfer signal TRG, thereby transferring the photo charges obtained through photoelectric conversion by the photoelectric conversion element 21 and accumulated in the photoelectric conversion element 21 to the floating diffusion FD.

The reset transistor 23 is connected between the node of the high potential-side power supply voltage V_{DD} and the floating diffusion FD. The gate of the reset transistor 23 receives the reset signal RST, which is active at a high level, from the row selection section 12. The reset transistor 23 becomes conductive in response to the reset signal RST, thereby discarding the charges in the floating diffusion FD to the node of the voltage V_{DD} to reset the floating diffusion FD.

The gate of the amplification transistor 24 is connected to the floating diffusion FD, and the drain thereof is connected to the node of the high potential-side power supply voltage V_{DD}. The amplification transistor 24 serves as the input section of a source follower configured to read the signals obtained through photoelectric conversion by the photoelectric conversion element 21. That is, the source of the amplification transistor 24 is connected to the signal line 32 via the selection transistor 25. Further, the amplification transistor 24 and the load current source I connected to one end of the signal line 32 form a source follower configured to convert the voltage of the floating diffusion FD into the potential of the signal line 32.

The drain of the selection transistor 25 is connected to the source of the amplification transistor 24, and the source thereof is connected to the signal line 32. The gate of the selection transistor 25 receives the selection signal SEL, which is active at a high level, from the row selection section 12. The selection transistor 25 becomes conductive in response to the selection signal SEL, thereby making the pixel 20 enter the selected state to transmit the signals output from the amplification transistor 24 to the signal line 32.

Note that, in the circuit example described above, as the circuit configuration of the pixel 20, the configuration including the four transistors, that is, the transfer transistor 22, the reset transistor 23, the amplification transistor 24, and the selection transistor 25, has been given as an example. However, the present disclosure is not limited to this. For example, a configuration in which the selection transistor 25 is omitted and the amplification transistor 24 has the function of the selection transistor 25, or a circuit configuration including more transistors as needed can be employed.

As for the semiconductor chip structure of the imaging device 10 configured as described above, a flat semiconductor chip structure and a stacked semiconductor chip structure can be exemplified. In the imaging device 10 of either the flat semiconductor chip structure or the stacked semiconductor chip structure, with regard to the pixels 20, back-illuminated and front-illuminated structures can be applied in a case where the substrate surface on which the wiring layers are arranged is used as the front surface (front). Here, the back-illuminated structure is a pixel structure that captures the light emitted from the back surface side opposite to the front surface. Meanwhile, the front-illuminated structure is a pixel structure that captures the light emitted from the front surface side. Now, the flat semiconductor chip structure and the stacked semiconductor chip structure are described.

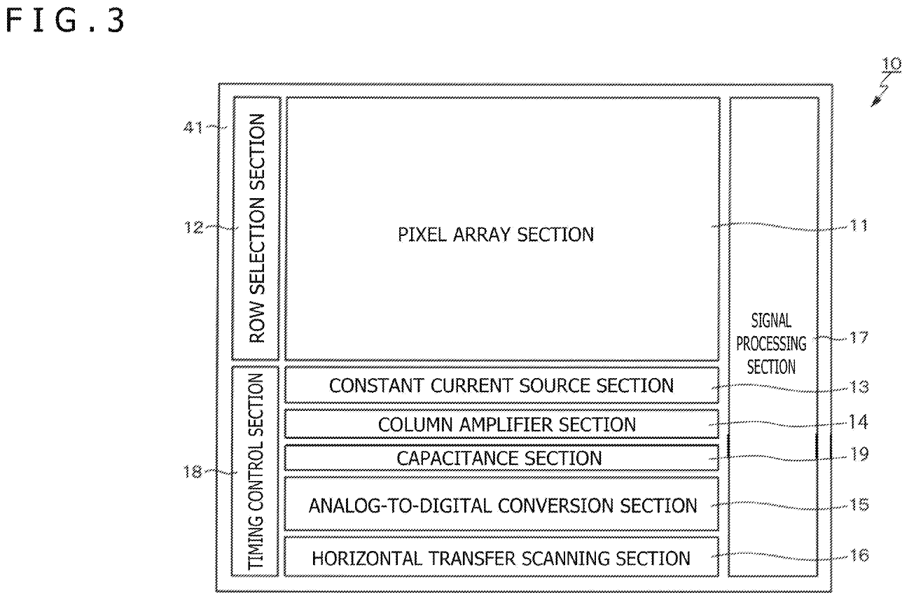

FIG. 3 is a plan view schematically depicting the outline of the flat semiconductor chip structure of the imaging device 10. As depicted in FIG. 3, the flat semiconductor chip structure is a structure in which the circuit sections around the pixel array section 11, which includes the pixels 20 arranged in a matrix, are formed on a semiconductor chip (semiconductor substrate) 41 on which the pixel array section 11 is also formed. Specifically, the row selection section 12, the constant current source section 13, the column amplifier section 14, the capacitance section 19, the analog-to-digital conversion section 15, the horizontal transfer scanning section 16, the signal processing section 17, the timing control section 18, and the like are formed on the semiconductor chip 41 on which the pixel array section 11 is also formed.

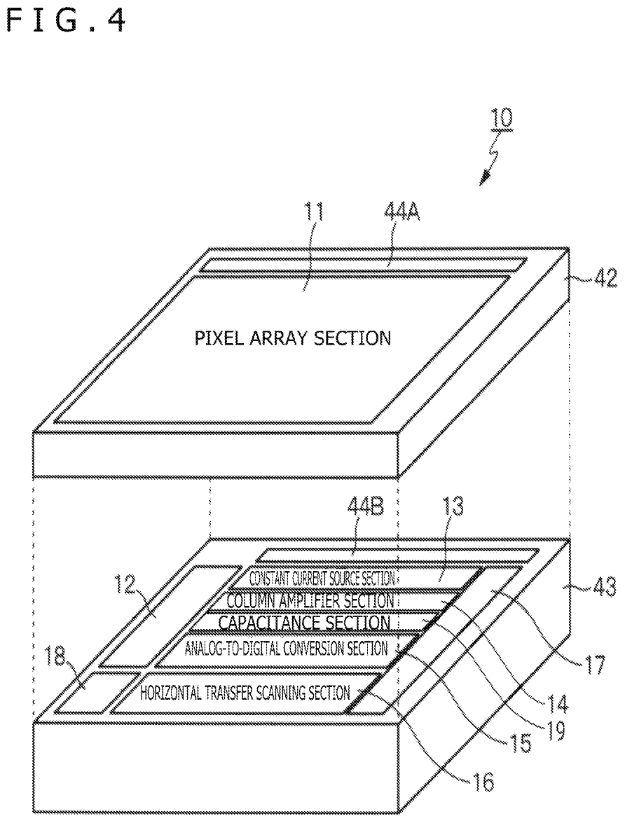

FIG. 4 is an exploded perspective view schematically depicting the outline of the stacked chip structure of the imaging device 10. As depicted in FIG. 4, the stacked semiconductor chip structure is a structure in which at least two semiconductor chips (semiconductor substrates), namely, a first-layer semiconductor chip 42 and a second-layer semiconductor chip 43, are stacked. In this stacked structure, the pixel array section 11 is formed on the first-layer semiconductor chip 42. Further, the circuit sections, such as the row selection section 12, the constant current source section 13, the column amplifier section 14, the capacitance section 19, the analog-to-digital conversion section 15, the horizontal transfer scanning section 16, the signal processing section 17, and the timing control section 18, are formed on the second-layer semiconductor chip 43. Further, the first-layer semiconductor chip 42 is electrically connected to the second-layer semiconductor chip 43 via connection sections (VIAs) 44A and 44B such as Cu-Cu connections.

With the imaging device 10 having this stacked structure, the first-layer semiconductor chip 42 is only required to have a size (area) that allows the formation of the pixel array section 11, and hence the size (area) of the first-layer semiconductor chip 42 and eventually the size of the entire chip can be reduced. Moreover, since a process suitable for producing the pixels 20 can be applied to the first-layer semiconductor chip 42 and a process suitable for producing the circuit sections can be applied to the second-layer semiconductor chip 43, there is also an advantage that the process of manufacturing the imaging device 10 can be optimized. In particular, an advanced process can be applied in producing the circuit sections.

Note that, here, the stacked structure of the two-layer structure including the first-layer semiconductor chip 42 and the second-layer semiconductor chip 43 that are stacked has been exemplified, but the stacked structure is not limited to the two-layer structure and may be a structure with three or more layers. Further, in the case of the stacked structure with three or more layers, the circuit sections, such as the row selection section 12, the constant current source section 13, the column amplifier section 14, the capacitance section 19, the analog-to-digital conversion section 15, the horizontal transfer scanning section 16, the signal processing section 17, and the timing control section 18, can be formed in a distributed manner on the semiconductor chips of the second and subsequent layers.

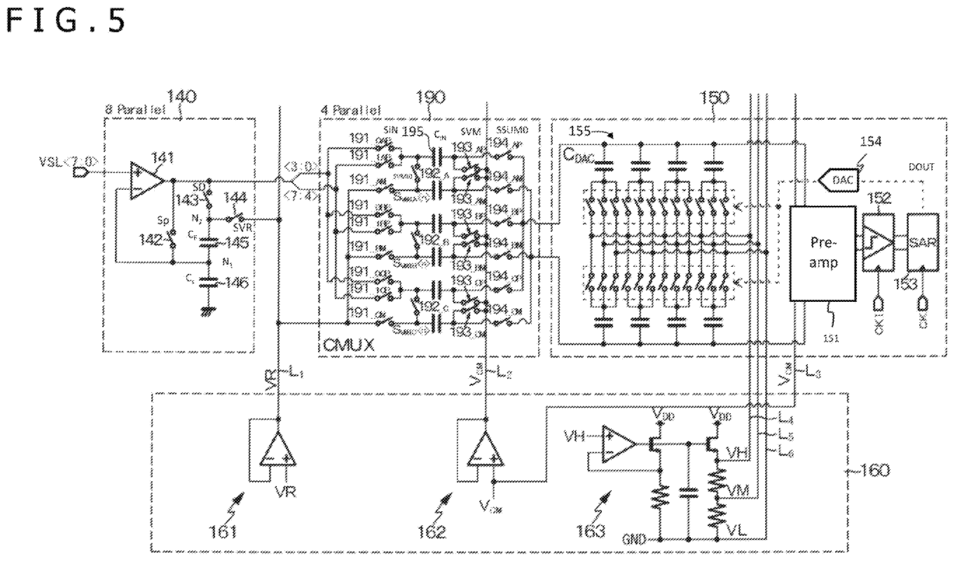

FIG. 5 is a circuit diagram depicting the schematic configuration of a column signal processing system provided in the imaging device 10. This column signal processing system includes the column amplifier 140 provided in the column amplifier section 14, a capacitance multiplexer 190 provided in the capacitance section 19, the successive approximation register analog-to-digital converter 150 provided in the analog-to-digital conversion section 15, and a reference voltage generation section 160.

The column amplifier 140 includes an amplifier 141, a first switch 142, a second switch 143, a third switch 144, a first capacitor 145, and a second capacitor 146. The first capacitor 145 has a capacitance value C_{F}, and the second capacitor 146 has a capacitance value C₅.

The amplifier 141 receives a potential VSL (VSL₀ to VSL₇) of the signal lines 32 as an input of its non-inverting input terminal (+). The first switch 142, one end and the other end of which are connected to the output terminal of the amplifier 141 and the inverting input terminal (−) of the amplifier 141, respectively, performs an on (close)/off (open) operation in response to the voltage level (high level/low level) of a switch control signal Sₚ.

One end of the second switch 143 is connected to the output terminal of the amplifier 141. One end of the first capacitor 145 is connected to the other end of the second switch 143, and the other end thereof is connected to the other end of the first switch 142 and the inverting input terminal of the amplifier 141. The second capacitor 146 is connected between the other end of the first capacitor 145 and the output terminal of the amplifier 141, and the node of a reference potential (for example, ground). The second switch 143 performs an on/off operation in response to the voltage level of a switch control signal SD.

That is, the second switch 143, the first capacitor 145, and the second capacitor 146 are connected in series in this order between the output terminal of the amplifier 141 and the node of the reference potential (for example, ground). Further, a common connection node N₁ between the first capacitor 145 and the second capacitor 146 is electrically connected to the other end of the first switch 142.

The third switch 144, one end of which is connected to a common connection node N₂ between the second switch 143 and the first capacitor 145, performs an on/off operation in response to the voltage level of a switch control signal S_{VR}. A local reference voltage VR for defining the zero voltage of an output of the column amplifier 140 is applied to the other end of the third switch 144. That is, the third switch 144 selectively applies the local reference voltage VR to the common connection node N₂ between the second switch 143 and the first capacitor 145.

The capacitance multiplexer 190 includes switches 191 to 194 and capacitors 195 and perform sampling by switched capacitors. The capacitors 195 have a capacitance value C_{IN}.

Each switch 191, one end of which is connected to the output end of the column amplifier 140, that is, the output terminal of the amplifier 141, performs an on/off operation in response to the voltage level of a switch control signal S_{IN}. Each switch 192, one end of which is connected to the other end of a corresponding one of the switches 191, performs an on/off operation in response to the voltage level of a switch control signal S_{VMI0}. A specific reference voltage VX is applied to the other ends of the switches 192. As the specific reference voltage VX, the local reference voltage VR may be used in some cases.

One end of each capacitor 195 is connected to the other end of a corresponding one of the switches 191. Each switch 193, one end of which is connected to the other end of a corresponding one of the capacitors 195, performs an on/off operation in response to the voltage level of a switch control signal S_{VM}. A medium voltage VM that is used to reset a capacitor array section (C_{DAC}) 155 of the successive approximation register analog-to-digital converter 150 is applied to the other ends of the switches 193.

Each switch 194, one end of which is connected to the other end of a corresponding one of the capacitors 195 and one end of a corresponding one of the switches 193, performs an on/off operation in response to the voltage level of a switch control signal S_{SUM0}. The other ends of the switches 194 are connected in common between the plurality of capacitance multiplexers 190 corresponding to the respective potentials VSL₀ to VSL₇ of the signal lines 32 and serve as the output end of the capacitance multiplexer 190.

The successive approximation register analog-to-digital converter 150 includes a preamplifier 151, a comparator 152, a SAR logic section 153, a digital-to-analog converter (DAC) 154, and the capacitor array section (C_{DAC}) 155.

The preamplifier 151 amplifies the voltage input to each of its inverting input terminal (−) and non-inverting input terminal (+). The inverting input terminal (−) is supplied with an analog voltage from the capacitance multiplexer 190, and the non-inverting input terminal (+) is supplied with an output common mode reference voltage V_{CM}. The circuit configuration of the preamplifier 151 is described later.

In synchronization with a comparator clock CKI, the comparator 152 compares the magnitudes of the output voltage of the preamplifier 151 and a comparison reference voltage to each other and supplies the result of the comparison to the SAR logic section 153. The circuit configuration of the comparator 152 is also described later.

The SAR logic section 153 includes, for example, an N-bit successive approximation register. In synchronization with a clock CK, the SAR logic section 153 stores the comparison result of the comparator 152 for each bit and outputs the comparison result as an N-bit digital signal value D_{OUT} after analog-to-digital conversion.

The digital-to-analog converter 154 and the capacitor array section 155 form an N-bit capacitive digital-to-analog converter. Further, in this capacitive digital-to-analog converter, the N-bit digital signal value D_{OUT} output from the SAR logic section 153 is converted into an analog voltage, and the voltage obtained through the conversion is input to the inverting input terminal (−) of the preamplifier 151.

The reference voltage generation section 160 includes a first amplifier section 161, a second amplifier section 162, and a third amplifier section 163. The first amplifier section 161 generates the local reference voltage VR for defining the zero voltage of an output of the column amplifier 140. The local reference voltage VR is supplied to the column amplifier 140 through a voltage line L₁. The second amplifier section 162 supplies the output common mode reference voltage V_{CM} of the preamplifier 151 to the capacitance multiplexer 190 through a voltage line L₂. The output common mode reference voltage V_{CM} is also supplied to the successive approximation register analog-to-digital converter 150 through a voltage line L₃. The third amplifier section 163 generates a high voltage VH, the medium voltage VM, and a low voltage VL for use in the capacitor array section (C_{DAC}) 155. The high voltage VH, the medium voltage VM, and the low voltage VL are supplied to the capacitor array section 155 through voltage lines L₄, L₅, and L₆.

During the P phase, the reference voltage generation section 160 charges the first capacitor 145 of the column amplifier 140 with the local reference voltage VR. During the D phase, the reference voltage generation section 160 sets the local reference voltage VR as a negative-side signal input to the capacitance multiplexer 190. The capacitance multiplexer 190 is configured differentially. A switch 192__{A}, a switch 192__{B}, and a switch 192__{C} on the input side are short-circuited between the differentials during comparison by the comparator 152 and are not connected to the common node. With this, the input side of the capacitance multiplexer 190 is completely isolated during comparison by the comparator 152, so that the settling of the capacitor array section 155 in the successive approximation register analog-to-digital converter 150 can be speeded up.

Switches 193__{AP} and 193__{AM}, switches 193__{BP} and 193__{BM}, and switches 193__{CP} and 193__{CM} on the output side of the capacitance multiplexer 190 are connected to the voltage line L₂ for transmitting the output common mode reference voltage V_{CM} and are in the on state during sampling. The output common mode reference voltage V_{CM} is the same voltage as the input operating potential of the preamplifier 151.

The high voltage VH, the medium voltage VM, and the low voltage VL generated by the third amplifier section 163 are reference voltages for the capacitor array section 155. Since the capacitor array section 155 operates at high speed during comparison by the comparator 152, the high voltage VH and the low voltage VL are required to achieve high-speed response and have a low impedance.

Here, for the specifications of power supply voltage, for example, 2.8 V (V_{DD}_H) and 0.8 V (V_{DD}_L) are assumed. The voltage of 2.8 is the same as the voltage used for the pixels 20 and used for the circuits of high breakdown voltage transistors. The voltage of 0.8 is assumed to be a voltage used for logic circuits. The potential VSL of the signal lines 32 is 2 V or more at maximum and hence cannot be handled by low breakdown voltage transistors. Thus, the column amplifier 140 is required to include a high breakdown voltage transistor. The successive approximation register analog-to-digital converter 150 is required to perform comparison operations at high speed and thus desirably includes a low breakdown voltage transistor. However, caution is required regarding the significant leakage current of the low breakdown voltage transistor.

Further, when a plurality of power supplies is involved between the loops of the successive approximation register analog-to-digital converter 150, an operation margin for absorbing variations between different power supplies is required, and it is therefore important to use a single power supply. The high voltage VH and the low voltage VL are set to 0.8 V (V_{DD}_L) and the same voltage as the ground, respectively, in order to sufficiently apply a gate voltage to the switches forming the capacitor array section 155. Since the voltage of an output of the column amplifier 140 is high, all the switches forming the capacitance multiplexer 190 include high breakdown voltage transistors.

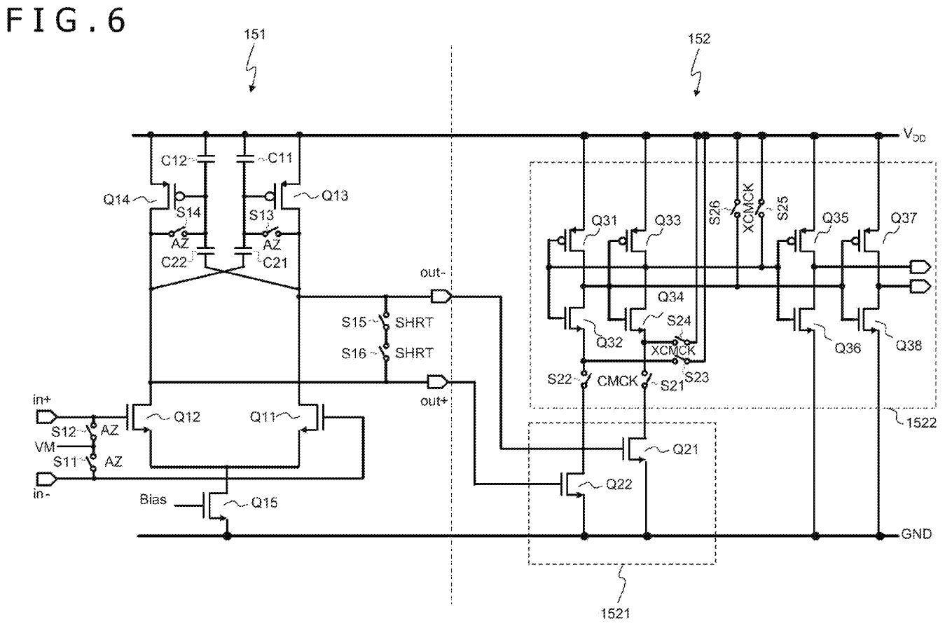

FIG. 6 is a diagram depicting the circuit configurations of the preamplifier 151 and the comparator 152 according to the first embodiment.

First, the circuit configuration of the preamplifier 151 is described. The preamplifier 151 includes, as depicted in FIG. 6, a first input transistor Q11, a second input transistor Q12, a first load transistor Q13, a second load transistor Q14, a bias transistor Q15, a first cancel capacitor C11, a second cancel capacitor C12, a first feedback capacitor C21, a second feedback capacitor C22, a first auto-zero switch element S11 to a fourth auto-zero switch element S14, a first reset switch element S15, and a second reset switch element S16. In the present embodiment, the first input transistor Q11, the second input transistor Q12, and the bias transistor Q15 include N-channel MOS transistors. Further, the first load transistor Q13 and the second load transistor Q14 include P-channel MOS transistors.

The gate of the first input transistor Q11 is connected to the inverting input terminal (−) of the preamplifier 151. The drain is connected to an output terminal out− corresponding to the inverting input terminal (−) and the first load transistor Q13. The source is connected to the bias transistor Q15.

The gate of the second input transistor Q12 is connected to the non-inverting input terminal (+) of the preamplifier 151. The drain is connected to an output terminal out+ corresponding to the non-inverting input terminal (+) and forming a pair with the above-mentioned output terminal out−, and to the second load transistor Q14. The source is connected to the bias transistor Q15 in common with the source of the first input transistor Q11.

The gate of the first load transistor Q13 is connected to the first cancel capacitor C11 and the first feedback capacitor C21. The source is connected to the power line for the power supply voltage V_{DD}. The drain is connected to the drain of the first input transistor Q11.

The gate of the second load transistor Q14 is connected to the second cancel capacitor C12 and the second feedback capacitor C22. The source is connected to the power line for the power supply voltage V_{DD}. The drain is connected to the drain of the second input transistor Q12.

The gate of the bias transistor Q15 receives a bias signal Bias as an input. The drain is connected to the source of each of the first input transistor Q11 and the second input transistor Q12 in common. The source is connected to the ground line. The bias transistor Q15 functions as a current source configured to supply, to the preamplifier 151, a current corresponding to the voltage level of the bias signal Bias input to the gate.

The first cancel capacitor C11 is provided between the gate and source of the first load transistor Q13. The second cancel capacitor C12 is provided between the gate and source of the second load transistor Q14. The first cancel capacitor C11 and the second cancel capacitor C12 function as capacitors configured to cancel the offset voltages of the first input transistor Q11 and the second input transistor Q12.

The first feedback capacitor C21 is provided between the gate of the first load transistor Q13 and the drain of the second input transistor Q12. The second feedback capacitor C22 is provided between the gate of the second load transistor Q14 and the drain of the first input transistor Q11. The first feedback capacitor C21 and the second feedback capacitor C22 function as positive feedback capacitors configured to increase the gain in amplifying the voltage input to the gate of the first input transistor Q11 from the inverting input terminal (−) and the voltage input to the gate of the second input transistor Q12 from the non-inverting input terminal (+).

The first auto-zero switch element S11 and the second auto-zero switch element S12 are connected in series between the gate of the first input transistor Q11 and the gate of the second input transistor Q12. The first auto-zero switch element S11 and the second auto-zero switch element S12 are turned on and off at the same timing in response to the voltage level of an auto-zero signal AZ. When the first auto-zero switch element S11 and the second auto-zero switch element S12 are turned on, the gate voltage of each of the first input transistor Q11 and the second input transistor Q12 is reset to the medium voltage VM. That is, the inverting input terminal (−) and non-inverting input terminal (+) of the successive approximation register analog-to-digital converter 150 are reset to the medium voltage VM.

The third auto-zero switch element S13 is provided between the gate and drain of the first load transistor Q13. The fourth auto-zero switch element S14 is provided between the gate and drain of the second load transistor Q14. The third auto-zero switch element S13 and the fourth auto-zero switch element S14 are also turned on and off at the same timing in response to the voltage level of the auto-zero signal AZ described above. When the third auto-zero switch element S13 and the fourth auto-zero switch element S14 are turned on, the offset of the second input transistor Q12 and the offset of the first input transistor Q11 are charged to the second feedback capacitor C22 and the first feedback capacitor C21, respectively. In contrast, when the third auto-zero switch element S13 and the fourth auto-zero switch element S14 are turned off, the first load transistor Q13 and the second load transistor Q14 are turned on.

The first reset switch element S15 and the second reset switch element S16 are connected in series between the drain of the first input transistor Q11 and the drain of the second input transistor Q12. The first reset switch element S15 and the second reset switch element S16 are turned on and off at the same timing in response to the voltage level of a reset signal SHRT. When the first reset switch element S15 and the second reset switch element S16 are turned on, the drain voltage of each of the first input transistor Q11 and the second input transistor Q12 is reset. That is, the output terminal of the successive approximation register analog-to-digital converter 150 is reset.

Next, the circuit configuration of the comparator 152 is described. The comparator 152 includes a latch circuit 1521 and a buffer circuit 1522, as depicted in FIG. 6. Now, each circuit is described.

The latch circuit 1521 includes a first latch transistor Q21 and a second latch transistor Q22. The first latch transistor Q21 and the second latch transistor Q22 include, for example, N-channel MOS transistors.

The gate of the first latch transistor Q21 is connected to an output terminal corresponding to the inverting input terminal (−) of the successive approximation register analog-to-digital converter 150. The gate of the second latch transistor Q22 is connected to an output terminal corresponding to the non-inverting input terminal (+) of the successive approximation register analog-to-digital converter 150. Further, the drain of each of the first latch transistor Q21 and the second latch transistor Q22 is connected to the buffer circuit 1522.

Moreover, the source of each of the first latch transistor Q21 and the second latch transistor Q22 is connected to the ground line.

The buffer circuit 1522 includes a first buffer transistor Q31 to an eighth buffer transistor Q38, and a first switch element S21 to a sixth switch element S26. The first buffer transistor Q31, the third buffer transistor Q33, the fifth buffer transistor Q35, and the seventh buffer transistor Q37 include P-channel MOS transistors. Further, the second buffer transistor Q32, the fourth buffer transistor Q34, the sixth buffer transistor Q36, and the eighth buffer transistor Q38 include N-channel MOS transistors.

The first buffer transistor Q31 and the second buffer transistor Q32 form a first inverter circuit. Specifically, the respective gates of the first buffer transistor Q31 and the second buffer transistor Q32 are connected to each other. Further, the respective drains are also connected to each other. The source of the first buffer transistor Q31 is connected to the power line. The source of the second buffer transistor Q32 is connected to the drain of the second latch transistor Q22 via the first switch element S21.

The third buffer transistor Q33 and the fourth buffer transistor Q34 form a second inverter circuit provided in the latter stage of the above-mentioned first inverter circuit. Specifically, the respective gates of the third buffer transistor Q33 and the fourth buffer transistor Q34 are connected to the drains of the first buffer transistor Q31 and the second buffer transistor Q32 in common. Further, the respective drains are connected to the gates of the first buffer transistor Q31 and the second buffer transistor Q32 in common. The source of the third buffer transistor Q33 is connected to the power line. The source of the fourth buffer transistor Q34 is connected to the drain of the first latch transistor Q21 via the second switch element S22.

The fifth buffer transistor Q35 and the sixth buffer transistor Q36 form a third inverter circuit provided in the latter stage of the above-mentioned second inverter circuit. Specifically, the respective gates of the fifth buffer transistor Q35 and the sixth buffer transistor Q36 are connected to the drains of the third buffer transistor Q33 and the fourth buffer transistor Q34 in common. Further, the respective drains are connected to each other, and to one of the pair of output terminals of the comparator 152 in common. The source of the fifth buffer transistor Q35 is connected to the power line. The source of the sixth buffer transistor Q36 is connected to the ground line.

The seventh buffer transistor Q37 and the eighth buffer transistor Q38 form a fourth inverter circuit provided in the latter stage of the above-mentioned third inverter circuit. Specifically, the respective gates of the seventh buffer transistor Q37 and the eighth buffer transistor Q38 are connected to the gates of the third buffer transistor Q33 and the fourth buffer transistor Q34 in common. Further, the respective drains are connected to the other of the pair of output terminals of the comparator 152 in common. The source of the seventh buffer transistor Q37 is connected to the power line. The source of the eighth buffer transistor Q38 is connected to the ground line.

The first switch element S21 is provided between the source of the fourth buffer transistor Q34 and the drain of the first latch transistor Q21. The second switch element S22 is provided between the source of the second buffer transistor Q32 and the drain of the second latch transistor Q22. The first switch element S21 and the second switch element S22 perform an on/off operation at the same timing in response to the voltage level of a first clock signal CMCK.

The third switch element S23 is provided between the source of the second buffer transistor Q32 and the power line. The fourth switch element S24 is provided between the source of the fourth buffer transistor Q34 and the power line. The third switch element S23 and the fourth switch element S24 perform an on/off operation at the same timing in response to the voltage level of a second clock signal XCMCK.

The fifth switch element S25 is provided between the gate of each of the fifth buffer transistor Q35 and the sixth buffer transistor Q36, and the power line. The sixth switch element S26 is provided between the gate of each of the seventh buffer transistor Q37 and the eighth buffer transistor Q38, and the power line. The fifth switch element S25 and the sixth switch element S26 also perform an on/off operation at the same timing in response to the voltage level of the second clock signal XCMCK.

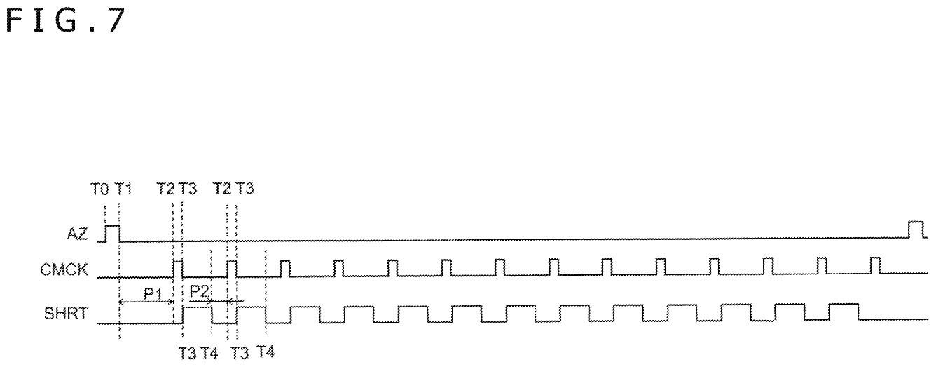

FIG. 7 is a timing chart depicting the operation of the successive approximation register analog-to-digital converter 150 according to the first embodiment. Now, with reference to FIG. 7, the operation of the successive approximation register analog-to-digital converter 150 is described. Here, the operation of the preamplifier 151 and the comparator 152 described above is described. FIG. 7 depicts the auto-zero signal AZ, the reset signal SHRT, and the first clock signal CMCK.

First, during an auto-zero (AZ) period from timing T0 before the initial analog-to-digital conversion to timing T1, the auto-zero signal AZ at a high level is input to each of the first auto-zero switch element S11 and the second auto-zero switch element S12 of the preamplifier 151. With this, the first input transistor Q11 and the second input transistor Q12 are turned off, and the gate potentials of the first input transistor Q11 and the second input transistor Q12, that is, the potentials of the inverting input terminal (−) and non-inverting input terminal (+) of the preamplifier 151, are reset.

Further, during the auto-zero period, the auto-zero signal AZ at a high level is also input to each of the third auto-zero switch element S13 and the fourth auto-zero switch element S14. With this, the first load transistor Q13 and the second load transistor Q14 are turned off. As a result, charges corresponding to the offsets of the first input transistor Q11 and the second input transistor Q12 are charged to the first cancel capacitor C11 and the second cancel capacitor C12.

Note that, during the auto-zero period, the reset signal SHRT is maintained at a low level. That is, during the auto-zero period, the pair of output terminals of the preamplifier 151 is not short-circuited. This is because, if the pair of output terminals of the preamplifier 151 is short-circuited during the auto-zero period, the first cancel capacitor C11 and the second cancel capacitor C12 cannot accurately hold charges corresponding to the offset generated on the output side of the preamplifier 151.

During a comparison period from timing T2, which comes after a predetermined time has elapsed from the auto-zero period, to timing T3, the first clock signal CMCK at a high level is input to each of the first switch element S21 and the second switch element S22. With this, the latch circuit 1521 is connected to the buffer circuit 1522 in the comparator 152. As a result, the voltages individually held by the first latch transistor Q21 and the second latch transistor Q22 of the latch circuit 1521 are amplified by the buffer circuit 1522 to be compared to each other. At this time, the first feedback capacitor C21 and the second feedback capacitor C22 of the preamplifier 151 function as positive feedback, thereby making it possible to make the gain larger than that in the auto-zero period. Thus, the offset is compressed.

During a reset period from the timing T3 at which the comparison period ends (the timing at which the first clock signal CMCK switches from a high level to a low level) to timing T4, the reset signal SHRT at a high level is input to each of the first reset switch element S15 and the second reset switch element S16. With this, the potentials of the pair of output terminals of the preamplifier 151 are reset. That is, as soon as the comparison by the comparator 152 is completed, the first reset switch element S15 and the second reset switch element S16 start to reset the potentials of the pair of output terminals of the preamplifier 151.

After that, the comparison period and the reset period are alternately repeated a plurality of times. That is, analog-to-digital conversion processing is performed a plurality of times. In the present embodiment, analog-to-digital conversion processing is performed 14 times. However, the number of times analog-to-digital conversion processing is performed by the comparator 152 is not limited to 14 and can be appropriately set depending on the number of bits of the digital signal value D_{OUT} output from the SAR logic section 153.

In the present embodiment described above, during the auto-zero period, charges corresponding to the offsets of the first input transistor Q11 and the second input transistor Q12 are charged to the first cancel capacitor C11 and the second cancel capacitor C12. Further, during the comparison period, the first feedback capacitor C21 and the second feedback capacitor C22 function as positive feedback capacitors configured to increase the gain of the preamplifier 151. Thus, the above-mentioned offsets are compressed. With this, the offsets of the first latch transistor Q21 and the second latch transistor Q22 of the comparator 152 configured to hold the signals (voltage) amplified by the preamplifier 151 are also compressed. With this, it is possible to avoid the appearance of vertical stripes in the images, thereby improving a decrease in image quality caused by the offset of the successive approximation register analog-to-digital converter 150.

Further, in the present embodiment, after the comparison operation of the comparator 152, the reset signal SHRT is used to short-circuit the pair of output terminals of the preamplifier 151. With this, it is possible to shorten the settling time required for the withdrawal of the increase in voltage due to positive feedback while utilizing the large gain by virtue of the first feedback capacitor C21 and the second feedback capacitor C22.

Moreover, in the present embodiment, during the auto-zero period, the reset signal SHRT is maintained at a low level, thereby preventing the short-circuit between the pair of output terminals of the preamplifier 151. Thus, the first cancel capacitor C11 and the second cancel capacitor C12 can accurately hold charges corresponding to the offset generated on the output side of the preamplifier 151.

### First Modified Example

Now, a first modified example of the first embodiment is described. In this modified example, the circuit configuration of the preamplifier of the successive approximation register analog-to-digital converter 150 is different from that of the first embodiment, while the other configurations are the same as those of the first embodiment. Thus, only the circuit configuration of the preamplifier is described here, and the description of the other configurations is omitted.

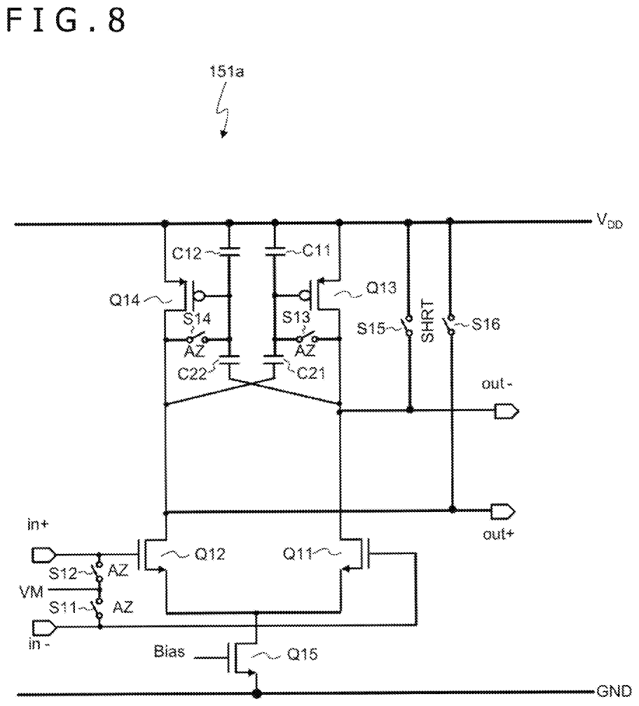

FIG. 8 is a diagram depicting the circuit configuration of a preamplifier according to the first modified example. In FIG. 8, the same components as those of the first embodiment described above are denoted by the same reference signs, and the detailed description thereof is omitted.

In a preamplifier 151a depicted in FIG. 8, the disposition of the first reset switch element S15 and the second reset switch element S16 is different from that of the first embodiment. In this modified example, the first reset switch element S15 is disposed between one of the pair of output terminals of the preamplifier 151a and the power line. Further, the second reset switch element S16 is disposed between the other of the pair of output terminals of the preamplifier 151a and the power line. The first reset switch element S15 and the second reset switch element S16 perform an on/off operation in response to the voltage level of the reset signal SHRT, as in the first embodiment.

Also in this modified example, as in the first embodiment, the reset signal SHRT at a high level is input to each of the first reset switch element S15 and the second reset switch element S16 during the reset period (the period from the timing T3 to the timing T4 depicted in FIG. 7) after the comparison period. With this, the first reset switch element S15 and the second reset switch element S16 are turned on, and the potentials of the output terminals of the preamplifier 151a are reset to the power supply voltage V_{DD}.

Thus, also in this modified example, it is possible to shorten the settling time required for the withdrawal of the increase in voltage due to positive feedback while utilizing the large gain by virtue of the first feedback capacitor C21 and the second feedback capacitor C22.

### Second Modified Example

Now, a second modified example of the first embodiment is described. In this modified example, the circuit configuration of the preamplifier of the successive approximation register analog-to-digital converter 150 is different from that of the first embodiment, while the other configurations are the same as those of the first embodiment. Thus, only the circuit configuration of the preamplifier is described, and the description of the other configurations is omitted here as well.

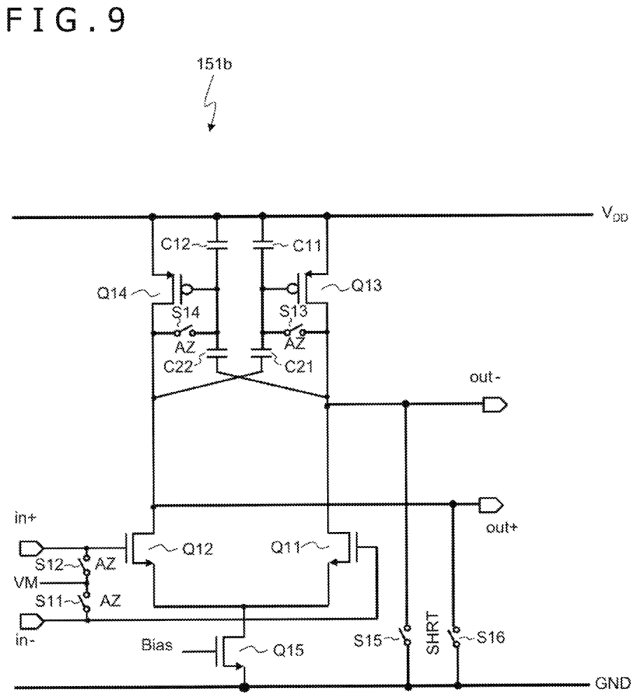

FIG. 9 is a diagram depicting the circuit configuration of a preamplifier according to the second modified example. In FIG. 9, the same components as those of the first embodiment described above are denoted by the same reference signs, and the detailed description thereof is omitted.

In a preamplifier 151b depicted in FIG. 9, the disposition of the first reset switch element S15 and the second reset switch element S16 is different from that of the first embodiment. In this modified example, the first reset switch element S15 is disposed between one of the pair of output terminals of the preamplifier 151a and the ground line. Further, the second reset switch element S16 is disposed between the other of the pair of output terminals of the preamplifier 151a and the ground line. The first reset switch element S15 and the second reset switch element S16 perform an on/off operation in response to the voltage level of the reset signal SHRT, as in the first embodiment.

Also in this modified example, as in the first embodiment, the reset signal SHRT at a high level is input to each of the first reset switch element S15 and the second reset switch element S16 during the reset period (the period from the timing T3 to the timing T4 depicted in FIG. 7) after the comparison period. With this, the first reset switch element S15 and the second reset switch element S16 are turned on, and the potentials of the output terminals of the preamplifier 151b are reset to a ground potential GND.

Thus, also in this modified example, it is possible to shorten the settling time required for the withdrawal of the increase in voltage due to positive feedback while utilizing the large gain by virtue of the first feedback capacitor C21 and the second feedback capacitor C22.

### Third Modified Example

Now, a third modified example of the first embodiment is described. In this modified example, the circuit configuration of the preamplifier of the successive approximation register analog-to-digital converter 150 is different from that of the first embodiment, while the other configurations are the same as those of the first embodiment. Thus, only the circuit configuration of the preamplifier is described, and the description of the other configurations is omitted here as well.

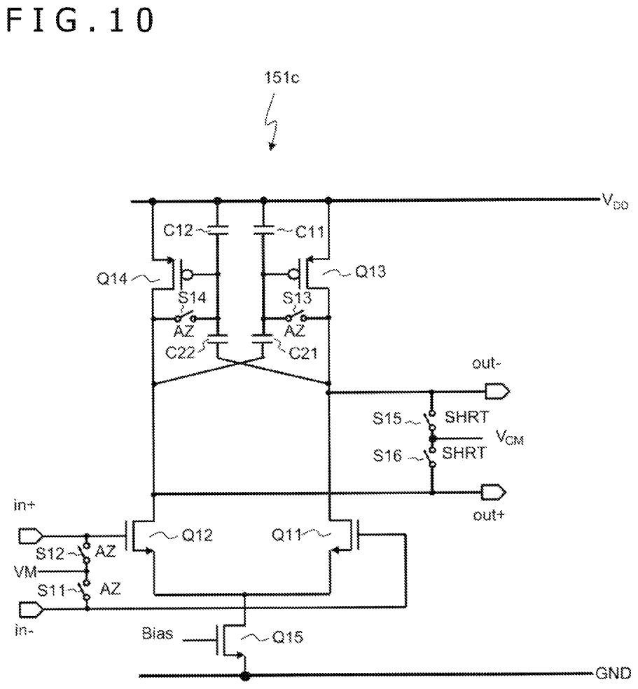

FIG. 10 is a diagram depicting the circuit configuration of a preamplifier according to the third modified example. In FIG. 10, the same components as those of the first embodiment described above are denoted by the same reference signs, and the detailed description thereof is omitted.

In a preamplifier 151c depicted in FIG. 10, the first reset switch element S15 and the second reset switch element S16 are connected in series between the pair of output terminals, as in the first embodiment. However, the potential of the connection portion between the first reset switch element S15 and the second reset switch element S16 is maintained at the same output common mode reference voltage V_{CM} as the non-inverting input terminal (+).

Also in this modified example, as in the first embodiment, the reset signal SHRT at a high level is input to each of the first reset switch element S15 and the second reset switch element S16 during the reset period (the period from the timing T3 to the timing T4 depicted in FIG. 7) after the comparison period. With this, the first reset switch element S15 and the second reset switch element S16 are turned on, and the potentials of the output terminals of the preamplifier 151b are reset to the output common mode reference voltage V_{CM}.

Thus, also in this modified example, it is possible to shorten the settling time required for the withdrawal of the increase in voltage due to positive feedback while utilizing the large gain by virtue of the first feedback capacitor C21 and the second feedback capacitor C22. Note that, the reset potential of the output terminals of the preamplifier 151b is not limited to the output common mode reference voltage V_{CM} and is only required to be any potential between the power supply voltage V_{DD} and the ground potential.

### Fourth Modified Example

Now, a fourth modified example of the first embodiment is described. In this modified example, the circuit configuration of the preamplifier of the successive approximation register analog-to-digital converter 150 is different from that of the first embodiment, while the other configurations are the same as those of the first embodiment. Thus, only the circuit configuration of the preamplifier is described, and the description of the other configurations is omitted here as well.

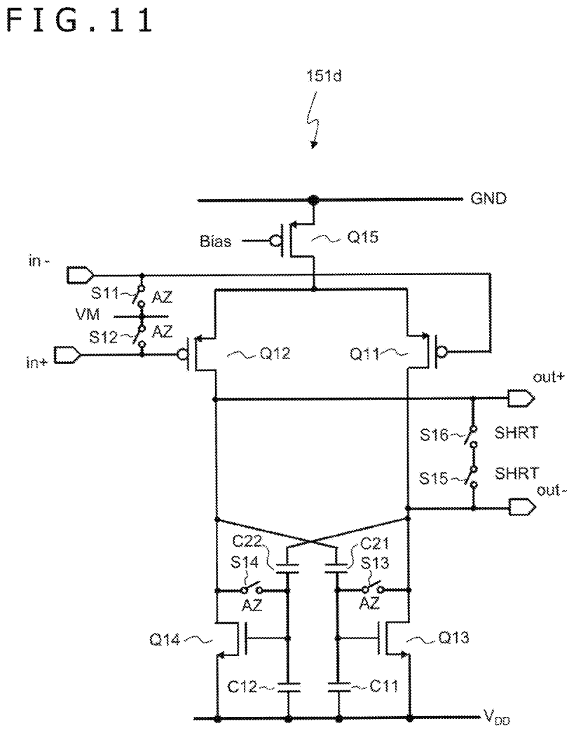

FIG. 11 is a diagram depicting the circuit configuration of a preamplifier according to the third modified example. In FIG. 11, the same components as those of the first embodiment described above are denoted by the same reference signs, and the detailed description thereof is omitted.

In a preamplifier 151d depicted in FIG. 11, the conductivity type of each transistor is opposite to those of the first embodiment. Specifically, in this modified example, the first input transistor Q11, the second input transistor Q12, and the bias transistor Q15 include P-channel MOS transistors. Further, the first load transistor Q13 and the second load transistor Q14 include N-channel MOS transistors.

Also in this modified example configured as described above, as in the first embodiment, during the auto-zero period, charges corresponding to the offsets of the first input transistor Q11 and the second input transistor Q12 are charged to the first cancel capacitor C11 and the second cancel capacitor C12. Further, during the comparison period, the first feedback capacitor C21 and the second feedback capacitor C22 function as positive feedback capacitors. Thus, the above-mentioned offsets are compressed. With this, it is possible to avoid the appearance of vertical stripes in the images, thereby improving the image quality.

### Fifth Modified Example

Now, a fifth modified example of the first embodiment is described. In this modified example, the circuit configuration of the preamplifier is the same as that of the first embodiment, and hence the description thereof is omitted. Note that, the successive approximation register analog-to-digital converter 150 according to this modified example may include any of the preamplifier 151a to the preamplifier 151d described in the respective modified examples instead of the preamplifier 151 described in the first embodiment.

In this modified example, the operation of the successive approximation register analog-to-digital converter 150 is different from that of the first embodiment. In the first embodiment, as depicted in FIG. 7, the time from the timing T1 at which the auto-zero period ends to the timing T2 at which the initial first clock signal CMCK is input is an initial amplification period P1 of the preamplifier 151. Further, the time from the timing T4 at which the reset signal SHRT changes from a high level to a low level to the next timing T2 is an amplification period P2 of the preamplifier 151, which corresponds to the second and subsequent amplification periods. As depicted in FIG. 7, the amplification period P1 is longer than the amplification period P2. Thus, it is anticipated that the impact of the short-circuit between the pair of output terminals of the preamplifier 151 is different between the initial analog-to-digital conversion processing and the second and subsequent analog-to-digital conversion processing of the successive approximation register analog-to-digital converter 150.

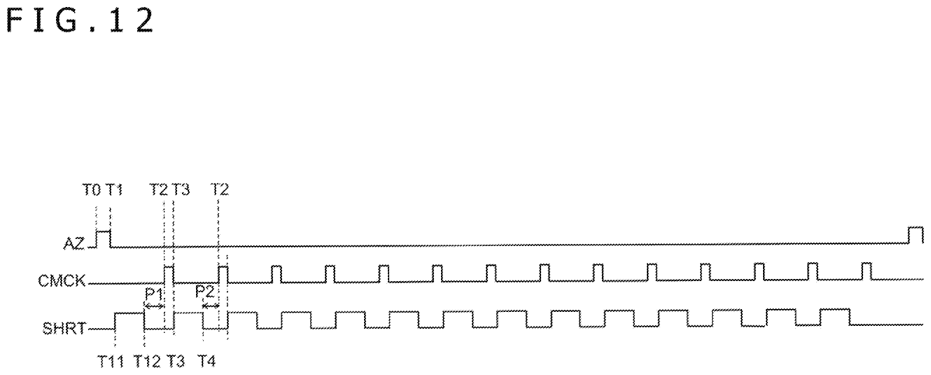

FIG. 12 is a timing chart depicting how the successive approximation register analog-to-digital converter 150 operates according to the fifth modified example. In this modified example, as depicted in FIG. 12, during the period from timing T11 to timing T12 between the timing T1 and the timing T2, the reset signal SHRT at a high level is input to each of the first reset switch element S15 and the second reset switch element S16. With this, the initial amplification period P1 of the preamplifier 151 occurs during the period from the timing T12, at which the reset signal SHRT changes from a high level to a low level, to the timing T2, at which the initial first clock signal CMCK is input.

As a result, the length of the initial amplification period P1 is the same as that of the amplification period P2, which corresponds to the second and subsequent amplification periods. Thus, according to this modified example, it is possible to equalize the impact of the short-circuit between the pair of output terminals of the preamplifier 151 between the initial analog-to-digital conversion processing and the second and subsequent analog-to-digital conversion processing of the successive approximation register analog-to-digital converter 150.

### Second Embodiment

A second embodiment is an example in which the imaging device described above is applied to an indirect TOF (Indirect-Time of Flight) distance image sensor. The indirect TOF distance image sensor is a sensor configured to measure the distance to an object to be measured (subject) by detecting the arrival phase difference of the light emitted from a light source and reflected by the object to be measured and measuring the time of flight of light on the basis of the detection.

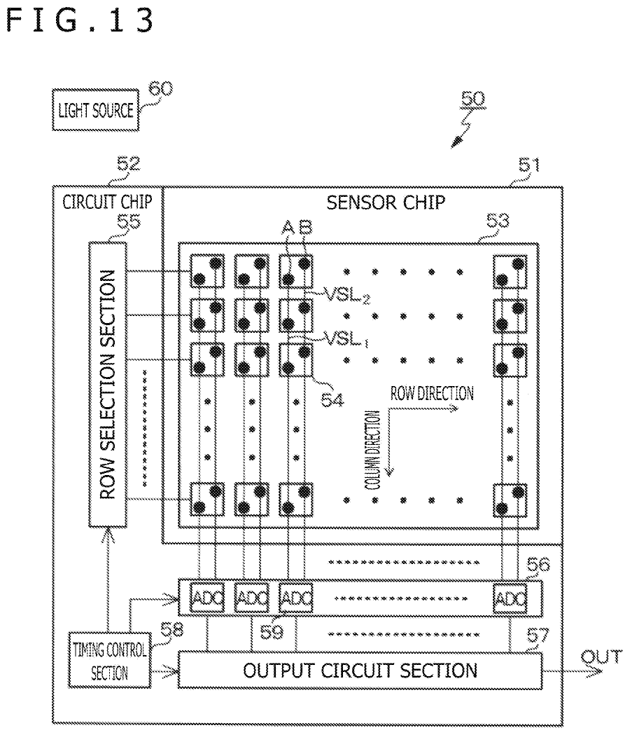

FIG. 13 is a block diagram depicting an example of the system configuration of an indirect TOF distance image sensor according to the second embodiment.

On an indirect TOF distance image sensor 50, light emitted from a light source 60 and reflected by an object to be measured (subject) is incident as reflected light. The indirect TOF distance image sensor 50 has a stacked structure including a sensor chip 51 and a circuit chip 52 stacked on the sensor chip 51. In this stacked structure, the sensor chip 51 is electrically connected to the circuit chip 52 through connection sections (not depicted) such as vias or Cu-Cu connections. Note that, FIG. 13 depicts the state in which the wiring of the sensor chip 51 is electrically connected to the wiring of the circuit chip 52 via the connection sections described above.

A pixel array section 53 is formed on the sensor chip 51. The pixel array section 53 includes a plurality of pixels 54 arranged in a matrix (array) in a two-dimensional grid pattern on the sensor chip 51. In the pixel array section 53, each of the plurality of pixels 54 receives incident light (for example, near-infrared light), performs photoelectric conversion, and outputs analog pixel signals. In the pixel array section 53, two signal lines VSL₁ and VSL₂ are arranged for each pixel column. When the number of pixel columns of the pixel array section 53 is M (M is an integer), a total of (2×M) signal lines VSL are arranged in the pixel array section 53.

Each of the plurality of pixels 54 has first and second taps A and B (details of which are described later). Among the two signal lines VSL₁ and VSL₂, to the signal line VSL₁, an analog pixel signal AIN_{P1} based on the charges of the first tap A of each pixel 54 in a corresponding one of the pixel columns is output. Further, to the signal line VSL₂, an analog pixel signal AIN_{P2} based on the charges of the second tap B of each pixel 54 in a corresponding one of the pixel columns is output. The analog pixel signals AIN_{P1} and AIN_{P2} are described later.

On the circuit chip 52, a row selection section 55, a column signal processing section 56, an output circuit section 57, and a timing control section 58 are disposed. The row selection section 55 drives each pixel 54 of the pixel array section 53 in units of pixel row to make the pixels 54 output the pixel signals AIN_{P1} and AIN_{P2}. Under the driving by the row selection section 55, the analog pixel signals AIN_{P1} and AIN_{P2} output from the pixels 54 in the selected row are supplied to the column signal processing section 56 through the two signal lines VSL₁ and VSL₂.

The column signal processing section 56 includes a plurality of analog-to-digital converters (ADC) 59 provided in correspondence with the pixel columns (for example, for each pixel column) of the pixel array section 53. The analog-to-digital converters 59 perform analog-to-digital conversion processing on the analog pixel signals AIN_{P1} and AIN_{P2} supplied through the signal lines VSL₁ and VSL₂ and output the result to the output circuit section 57. The output circuit section 57 performs predetermined signal processing on the digitized pixel signals AIN_{P1} and AIN_{P2} output from the column signal processing section 56 and outputs the result to the outside of the circuit chip 52.

The timing control section 58 generates various timing signals, clock signals, control signals, and the like, and controls, on the basis of these signals, the driving of the row selection section 55, the column signal processing section 56, the output circuit section 57, and the like.

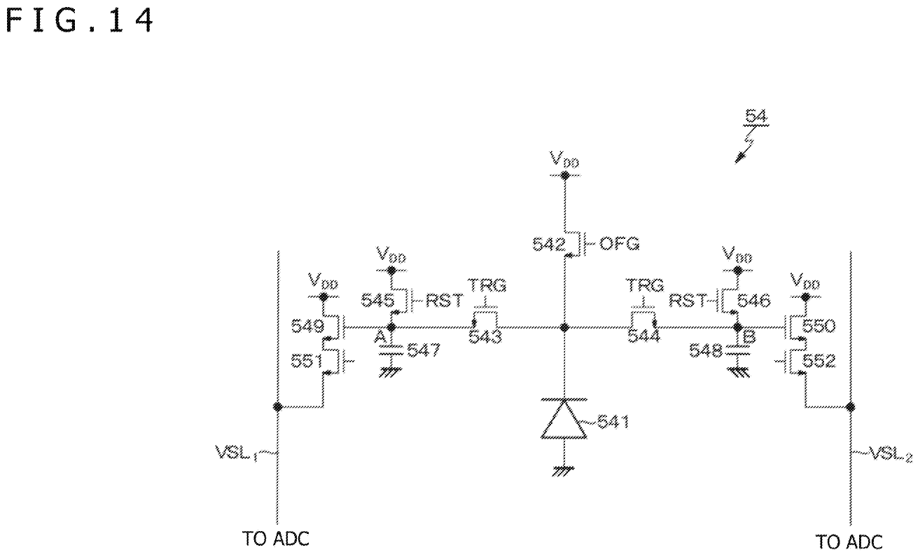

FIG. 14 is a circuit diagram depicting an example of the circuit configuration of the pixel 54 according to the second embodiment.

The pixel 54 according to the present embodiment includes a photodiode 541 as a photoelectric conversion element, for example. In addition to the photodiode 541, the pixel 54 includes an overflow transistor 542, two transfer transistors 543 and 544, two reset transistors 545 and 546, two floating diffusion layers 547 and 548, two amplification transistors 549 and 550, and two selection transistors 551 and 552. The two floating diffusion layers 547 and 548 correspond to the first and second taps A and B (hereinafter sometimes simply referred to as “taps A and B”) depicted in FIG. 13.

The photodiode 541 photoelectrically converts the received light to generate charges. The photodiode 541 can have, for example, a back-illuminated pixel structure. However, the photodiode 541 is not limited to the back-illuminated structure and can have a front-illuminated structure that captures the light emitted from the substrate front surface side.

The overflow transistor 542 is connected between the cathode of the photodiode 541 and a power line for the power supply voltage V_{DD} and functions to reset the photodiode 541. Specifically, the overflow transistor 542 becomes conductive in response to an overflow gate signal TRG supplied from the row selection section 55, thereby sequentially transferring the charges generated by the photodiode 541 to each of the floating diffusion layers 547 and 548.

The floating diffusion layers 547 and 548 corresponding to the first and second taps A and B accumulate the charges transferred from the photodiode 541 and convert the charges into voltage signals with voltage values corresponding to the amounts of charge, thereby generating the pixel signals AIN_{P1} and AIN_{P2}.

The two reset transistors 545 and 546 are connected between the two respective floating diffusion layers 547 and 548 and the power line for the power supply voltage V_{DD}. Further, the reset transistors 545 and 546 become conductive in response to the reset signal RST supplied from the row selection section 55, thereby extracting the charges from the respective floating diffusion layers 347 and 348 to initialize the amounts of charge.

The two amplification transistors 549 and 550 are connected between the power line for the power supply voltage V_{DD} and the two respective selection transistors 551 and 552. The amplification transistors 549 and 550 amplify the voltage signals obtained by the respective floating diffusion layers 547 and 548 converting charges into voltages.

The two selection transistors 551 and 552 are connected between the two respective amplification transistors 549 and 550 and the respective signal lines VSL₁ and VSL₂. Further, the selection transistors 551 and 552 become conductive in response to the selection signal SEL supplied from the row selection section 55, thereby outputting the voltage signals amplified by the respective amplification transistors 549 and 550 to the two signal lines VSL₁ and VSL₂ as the analog pixel signals AIN_{P1} and AIN_{P2}.

The two signal lines VSL₁ and VSL₂ are connected to the input end of a corresponding one of the analog-to-digital converters 59 in the column signal processing section 56 for each pixel column. The signal lines VSL₁ and VSL₂ transmit the analog pixel signals AIN_{P1} and AIN_{P2} output from the pixels 54 for each pixel column to the analog-to-digital converter 59.

Note that, the circuit configuration of the pixel 54 can be any circuit configuration that can generate the analog pixel signals AIN_{P1} and AIN_{P2} through photoelectric conversion and is not limited to the circuit configuration exemplified in FIG. 14.

In the indirect TOF distance image sensor 50 described above, the analog-to-digital converters 59 can be applied to the technology according to one of the first embodiment and each modified example described above. More specifically, the analog-to-digital converters 59 can be applied to the successive approximation register analog-to-digital converters 150 described in the first embodiment and each modified example.

### Third Embodiment

Here, the case of applying the technology according to one of the first embodiment and each modified example to imaging systems such as digital still cameras and video cameras, mobile terminal devices having an imaging function such as mobile phones, and electronic apparatuses such as copying machines using an imaging device for an image reading section is described.

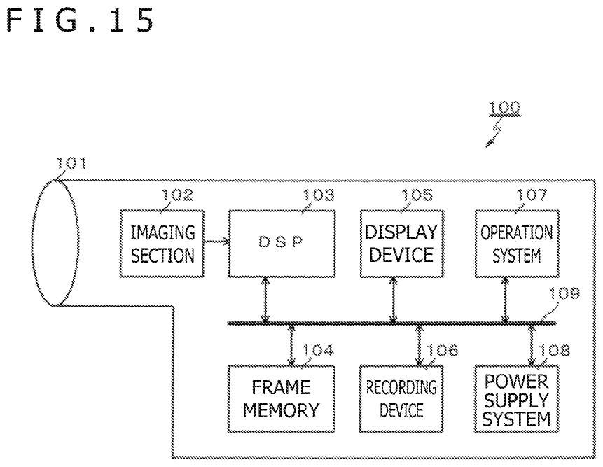

FIG. 15 is a block diagram depicting a configuration example of an electronic apparatus according to a third embodiment.

As depicted in FIG. 15, an electronic apparatus 100 according to the present embodiment includes an imaging optical system 101 including a lens group and the like, an imaging section 102, a DSP (Digital Signal Processor) circuit 103, a frame memory 104, a display device 105, a recording device 106, an operation system 107, a power supply system 108, and the like. Further, the DSP circuit 103, the frame memory 104, the display device 105, the recording device 106, the operation system 107, and the power supply system 108 are connected to each other via a bus line 109.

The imaging optical system 101 captures incident light (image light) from a subject and forms an image of the light on the imaging surface of the imaging section 102. The imaging section 102 converts the amount of incident light, an image of which has been formed on the imaging surface by the imaging optical system 101, into electric signals in units of pixel and outputs the electric signals as pixel signals. The DSP circuit 103 performs general camera signal processing such as white balance processing, demosaic processing, or gamma correction processing.

The frame memory 104 is appropriately used to store data in the process of signal processing in the DSP circuit 103. The display device 105 includes a panel display device such as a liquid crystal display device or an organic EL (electro luminescence) display device and displays the moving images or still images captured by the imaging section 102. The recording device 106 records the moving images or still images captured by the imaging section 102 on recording media such as portable semiconductor memories, optical discs, or HDDs (Hard Disk Drives).

The operation system 107 issues operation commands for various functions of the electronic apparatus 100 under the operation of the user. The power supply system 108 appropriately supplies, as operating power sources, various power sources to the DSP circuit 103, the frame memory 104, the display device 105, the recording device 106, and the operation system 107.

In the electronic apparatus 100 configured as described above, the imaging device according to the first embodiment described above can be used as the imaging section 102. In the imaging device 10 according to the first embodiment, in particular, the successive approximation register analog-to-digital converters 150 are excellent in power efficiency, and hence, by applying the imaging device to the imaging section 102, it is possible to contribute to a reduction in power consumption of the electronic apparatus 100.

### Application Example to Mobile Body

The technology according to the present disclosure (present technology) can be applied to various products. For example, the technology according to the present disclosure may be implemented as a device that is mounted on a mobile body of any type, such as automobiles, electric vehicles, hybrid electric vehicles, motorcycles, bicycles, personal mobilities, airplanes, drones, ships, and robots.

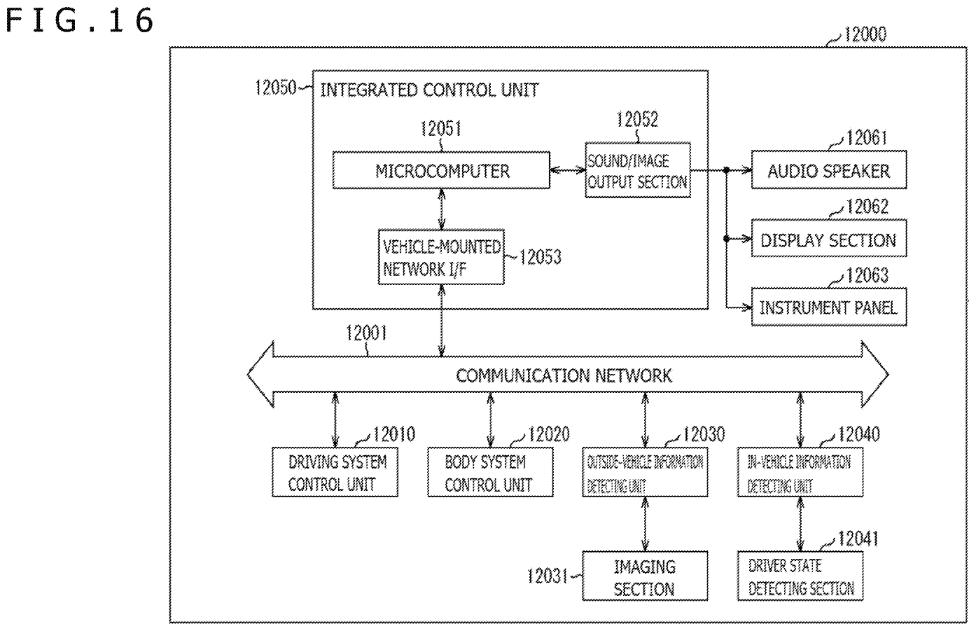

FIG. 16 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 16, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 16, an audio speaker 12061, a display section 12062, and an instrument panel 12063 are illustrated as the output device. The display section 12062 may, for example, include at least one of an on-board display and a head-up display.

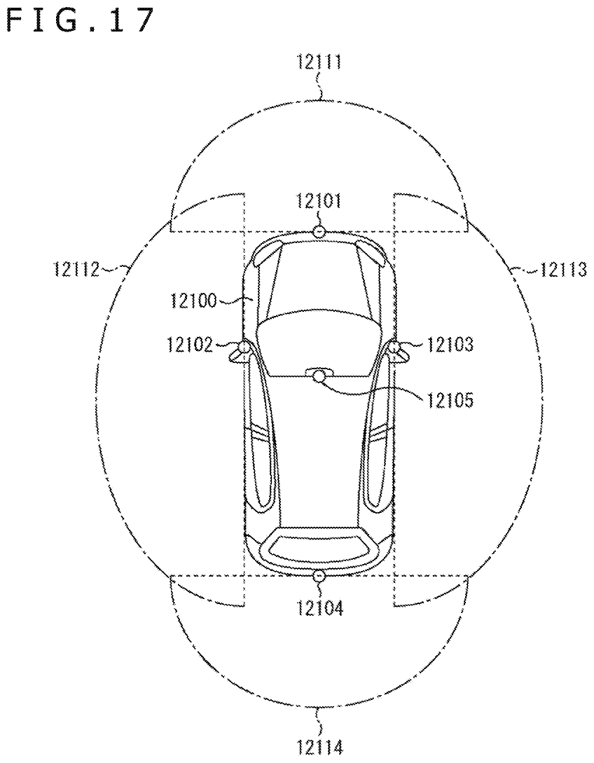

FIG. 17 is a diagram depicting an example of the installation position of the imaging section 12031.

In FIG. 17, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 17 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object.

When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the imaging sections 7910, 7912, 7914, 7916, and 7918 and the outside-vehicle information detecting sections 7920, 7922, 7924, 7926, 7928, and 7930, among the configurations described above, for example. Further, in particular, the successive approximation register analog-to-digital converters 150 are excellent in power efficiency, and hence by applying the technology according to the present disclosure, it is possible to contribute to a reduction in power consumption of the vehicle control system.

It is to be noted that the present technology can also adopt the following configurations.

(1)

An imaging device including:
a pixel configured to photoelectrically convert incident light, and
a successive approximation register analog-to-digital converter configured to perform digital conversion processing a plurality of times on an analog signal generated on the basis of photoelectric conversion by the pixel, in which
the successive approximation register analog-to-digital converter includes
   a preamplifier configured to amplify a voltage input to each of an inverting input terminal and a non-inverting input terminal, and
   a comparator configured to compare voltages input from respective ones of a pair of output terminals of the preamplifier to each other, and
the preamplifier includes
   a first input transistor having a gate connected to the inverting input terminal,
   a second input transistor having a gate connected to the non-inverting input terminal,
   an auto-zero switch element configured to reset gate potentials of the first input transistor and the second input transistor before initial digital conversion processing,
   a cancel capacitor configured to charge a charge corresponding to an offset during resetting of the first input transistor and the second input transistor,
   a feedback capacitor configured to make, during comparison by the comparator, a gain of the preamplifier larger than the gain during the resetting, and
   a reset switch element configured to reset potentials of the pair of output terminals every time the comparison by the comparator is completed.
      (2)

The imaging device according to (1), in which
the preamplifier further includes
   a first load transistor connected in series to the first input transistor, and
   a second load transistor connected in series to the second input transistor,
the auto-zero switch element includes
   a first auto-zero switch element and a second auto-zero switch element connected in series between the gate of the first input transistor and the gate of the second input transistor,
   a third auto-zero switch element provided between a gate and a drain of the first load transistor, and
   a fourth auto-zero switch element provided between a gate and a drain of the second load transistor,
the cancel capacitor includes
   a first cancel capacitor provided between the gate and a source of the first load transistor, and
   a second cancel capacitor provided between the gate and a source of the second load transistor, and
the feedback capacitor includes
   a first feedback capacitor provided between the gate of the first load transistor and a drain of the second input transistor, and
   a second feedback capacitor provided between the gate of the second load transistor and a drain of the first input transistor.
      (3)

The imaging device according to (2), in which the reset switch element includes a first reset switch element and a second reset switch element connected in series between the pair of output terminals.

(4)

The imaging device according to (2), in which the reset switch element includes a first reset switch element provided between one of the pair of output terminals and a power line, and a second reset switch element provided between another of the pair of output terminals and the power line.

(5)

The imaging device according to (2), in which the reset switch element includes a first reset switch element provided between one of the pair of output terminals and a ground line, and a second reset switch element provided between another of the pair of output terminals and the ground line.

(6)

The imaging device according to (3), in which a potential of a connection portion between the first reset switch element and the second reset switch element is maintained at any potential between a power supply voltage and a ground potential.

(7)

The imaging device according to any one of (2) to (6), in which
the first input transistor and the second input transistor are N-channel MOS transistors, and
the first load transistor and the second load transistor are P-channel MOS transistors.
   (8)

The imaging device according to (2), in which
the first input transistor and the second input transistor are P-channel MOS transistors, and
the first load transistor and the second load transistor are N-channel MOS transistors.
   (9)

The imaging device according to any one of (1) to (8), in which the reset switch element resets the potentials of the pair of output terminals in a time between an auto-zero period in which the auto-zero switch element resets the gate potentials of the first input transistor and the second input transistor, and an initial comparison period of the comparator.

(10)

The imaging device according to any one of (1) to (9), in which the reset switch element does not reset the potentials of the pair of output terminals when the auto-zero switch element resets the gate potentials of the first input transistor and the second input transistor.

(11)

The imaging device according to any one of (1) to (10), in which, as soon as the comparison by the comparator is completed, the reset switch element starts to reset the potentials of the pair of output terminals.

(12)

An electronic apparatus including:
an imaging device including a pixel configured to photoelectrically convert incident light, and a successive approximation register analog-to-digital converter configured to perform digital conversion processing a plurality of times on an analog signal generated on the basis of photoelectric conversion by the pixel, in which
the successive approximation register analog-to-digital converter includes a preamplifier configured to amplify a voltage input to each of an inverting input terminal and a non-inverting input terminal, and a comparator configured to compare voltages input from respective ones of a pair of output terminals of the preamplifier to each other, and
the preamplifier includes
   a first input transistor having a gate connected to the inverting input terminal,
   a second input transistor having a gate connected to the non-inverting input terminal,
   an auto-zero switch element configured to reset gate potentials of the first input transistor and the second input transistor before initial digital conversion processing,
   a cancel capacitor configured to charge a charge corresponding to an offset during resetting of the first input transistor and the second input transistor,
   a feedback capacitor configured to make, during comparison by the comparator, a gain of the preamplifier larger than the gain during the resetting, and
   a reset switch element configured to reset potentials of the pair of output terminals every time the comparison by the comparator is completed.

### REFERENCE SIGNS LIST

10: Imaging device
20: Pixel
150: Successive approximation register analog-to-digital converter
151: Preamplifier
152: Comparator
Q11: First input transistor
Q12: Second input transistor
Q13: First load transistor
Q14: Second load transistor
S11: First auto-zero switch element
S12: Second auto-zero switch element
S13: Third auto-zero switch element
S14: Fourth auto-zero switch element
S15: First reset switch element
S16: Second reset switch element
C11: First cancel capacitor
C12: Second cancel capacitor
C21: First feedback capacitor
C22: Second feedback capacitor

1. An imaging device comprising:
a pixel configured to photoelectrically convert incident light; and
a successive approximation register analog-to-digital converter configured to perform digital conversion processing a plurality of times on an analog signal generated on a basis of photoelectric conversion by the pixel, wherein
the successive approximation register analog-to-digital converter includes
a preamplifier configured to amplify a voltage input to each of an inverting input terminal and a non-inverting input terminal, and
a comparator configured to compare voltages input from respective ones of a pair of output terminals of the preamplifier to each other, and
the preamplifier includes
a first input transistor having a gate connected to the inverting input terminal,
a second input transistor having a gate connected to the non-inverting input terminal,
an auto-zero switch element configured to reset gate potentials of the first input transistor and the second input transistor before initial digital conversion processing,
a cancel capacitor configured to charge a charge corresponding to an offset during resetting of the first input transistor and the second input transistor,
a feedback capacitor configured to make, during comparison by the comparator, a gain of the preamplifier larger than the gain during the resetting, and
a reset switch element configured to reset potentials of the pair of output terminals every time the comparison by the comparator is completed.

2. The imaging device according to claim 1, wherein
the preamplifier further includes
a first load transistor connected in series to the first input transistor, and
a second load transistor connected in series to the second input transistor,
the auto-zero switch element includes
a first auto-zero switch element and a second auto-zero switch element connected in series between the gate of the first input transistor and the gate of the second input transistor,
a third auto-zero switch element provided between a gate and a drain of the first load transistor, and
a fourth auto-zero switch element provided between a gate and a drain of the second load transistor,
the cancel capacitor includes
a first cancel capacitor provided between the gate and a source of the first load transistor, and
a second cancel capacitor provided between the gate and a source of the second load transistor, and
the feedback capacitor includes
a first feedback capacitor provided between the gate of the first load transistor and a drain of the second input transistor, and
a second feedback capacitor provided between the gate of the second load transistor and a drain of the first input transistor.

3. The imaging device according to claim 2, wherein the reset switch element includes a first reset switch element and a second reset switch element connected in series between the pair of output terminals.

4. The imaging device according to claim 2, wherein the reset switch element includes a first reset switch element provided between one of the pair of output terminals and a power line, and a second reset switch element provided between another of the pair of output terminals and the power line.

5. The imaging device according to claim 2, wherein the reset switch element includes a first reset switch element provided between one of the pair of output terminals and a ground line, and a second reset switch element provided between another of the pair of output terminals and the ground line.

6. The imaging device according to claim 3, wherein a potential of a connection portion between the first reset switch element and the second reset switch element is maintained at any potential between a power supply voltage and a ground potential.

7. The imaging device according to claim 2, wherein
the first input transistor and the second input transistor are N-channel MOS transistors, and
the first load transistor and the second load transistor are P-channel MOS transistors.

8. The imaging device according to claim 2, wherein
the first input transistor and the second input transistor are P-channel MOS transistors, and
the first load transistor and the second load transistor are N-channel MOS transistors.

9. The imaging device according to claim 1, wherein the reset switch element resets the potentials of the pair of output terminals in a time between an auto-zero period in which the auto-zero switch element resets the gate potentials of the first input transistor and the second input transistor, and an initial comparison period of the comparator.

10. The imaging device according to claim 1, wherein the reset switch element does not reset the potentials of the pair of output terminals when the auto-zero switch element resets the gate potentials of the first input transistor and the second input transistor.

11. The imaging device according to claim 1, wherein, as soon as the comparison by the comparator is completed, the reset switch element starts to reset the potentials of the pair of output terminals.

12. An electronic apparatus comprising:
an imaging device including a pixel configured to photoelectrically convert incident light, and a successive approximation register analog-to-digital converter configured to perform digital conversion processing a plurality of times on an analog signal generated on a basis of photoelectric conversion by the pixel, wherein
the successive approximation register analog-to-digital converter includes a preamplifier configured to amplify a voltage input to each of an inverting input terminal and a non-inverting input terminal, and a comparator configured to compare voltages input from respective ones of a pair of output terminals of the preamplifier to each other, and
the preamplifier includes
a first input transistor having a gate connected to the inverting input terminal,
a second input transistor having a gate connected to the non-inverting input terminal,
an auto-zero switch element configured to reset gate potentials of the first input transistor and the second input transistor before initial digital conversion processing,
a cancel capacitor configured to charge a charge corresponding to an offset during resetting of the first input transistor and the second input transistor,
a feedback capacitor configured to make, during comparison by the comparator, a gain of the preamplifier larger than the gain during the resetting, and
a reset switch element configured to reset potentials of the pair of output terminals every time the comparison by the comparator is completed.
